(19) United States
(12) Patent Application Publication
(10) Pub. No.: US 2016/0070101 A1
(43) Pub. Date: Mar. 10, 2016

(54) HEAD MOUNTED DISPLAY DEVICE, CONTROL METHOD FOR HEAD MOUNTED DISPLAY DEVICE, INFORMATION SYSTEM, AND COMPUTER PROGRAM

(71) Applicant: SEIKO EPSON CORPORATION, Tokyo (JP)

(72) Inventor: Kazuo NISHIZAWA, Matsumoto-shi (JP)

(21) Appl. No.: 14/830,343

(22) Filed: Aug. 19, 2015

(30) Foreign Application Priority Data
Sep. 9, 2014 (JP) 2014-183284

(51) Int. Cl. G02B 27/01; G06K 9/00; G06F 3/01

(52) U.S. Cl. CPC G02B 27/017; G02B 27/0101; G06F 3/013; G06K 9/00671; G02B 2027/0138; G02B 2027/014; G02B 2027/0178

(57) ABSTRACT

A transmission type head mounted display device includes an imaging unit that images an outside scene, an image display unit that displays an image and is capable of transmitting the outside scene, an action detection unit that detects an action of a user, and a function determination unit that determines a function which can be executed by the head mounted display device in a case where an action situation which is a combination of the detected action and the imaged outside scene is a predetermined situation.

### BACKGROUND

1. Technical Field

The present invention relates to a head mounted display device.

2. Related Art

A head mounted display device (HMD) that is a display device mounted on a head is known. The head mounted display device, for example, generates an image light using a liquid crystal display and a light source, guides the generated image light to the eyes of a user using a projection optical system and a light guide plate, and causes the user to visually recognize a virtual image. Of the head mounted display device, there are two types: a transmission type device with which the user can visually recognize an outside scene in addition to the virtual image and a non-transmission type with which the user cannot visually recognize the outside scene. There are two types of the transmission type head mounted display device: an optical transmission type head mounted display device and a video transmission type head mounted display device.

In JP-A-2002-342653, an information providing system is disclosed, in which, when a vehicle passes through an entrance gate installed on the entrance of the parking place of a shopping center, a server that stores information of each store in the shopping center acquires personal information, or the like registered in the vehicle and provides information of the store associated with the acquired personal information to the vehicle passing through the entrance gate.

However, in the technology disclosed in JP-A-2002-342653, in a case where the vehicle passes through the specific location such as the entrance gate, information associated with the specific location is provided to the user such as a driver of the vehicle. However, it is desirable that the information is provided to the user without being limited to the specific location.

### SUMMARY

An advantage of some aspects of the invention is to solve at least a part of the problems described above, and the invention can be implemented as the following aspects.

(1) An aspect of the invention provides a transmission type head mounted display device. The head mounted display device includes: an imaging unit that images an outside scene; an image display unit that displays the image and is capable of transmitting the outside scene; an action detection unit that detects an action of a user; and a function determination unit that determines a function which can be executed by the head mounted display device in a case where an action situation which is a combination of the detected action and the imaged outside scene is a predetermined situation. According to this type of head mounted display device, since the function of the head mounted display device that is considered not necessary to the user is limited according to the action situation of the user regardless of the place, it is possible to provide only the function necessary to the user according to the situation, and thus, the convenience to the user is further improved.

(2) The head mounted display device according to the aspect may further include a display image control unit that displays an associated display image associated with at least one of the determined function and the action situation on the image display unit in a case where the action situation is the predetermined situation. According to this type of head mounted display device, the user can visually recognize the information relating to the action situation, and thus, the convenience to the user is improved.

(3) The head mounted display device according to the aspect may further include a position specification unit that specifies a current position of the image display unit in a case where the action situation is the predetermined situation; and an information transmission and reception unit that transmits position information representing a specified current position to another device and receives local information which is based. on the position information. The display image control unit may display the image associated with the received local information on the image display unit as the associated display image. According to this type of head mounted display device, the associated display image in which the current position of the image display unit is added in addition to the detected action situation of the user is displayed on the image display unit. Therefore, it is possible to cause the user to visually recognize the information which is necessary for the user, and thus, the usability to the user is improved.

(4) In the head mounted display device according to the aspect, the action detection unit detects a line-of-sight direction of the user as the action of the user, and in a case where the action situation is the predetermined situation and a detected line-of-sight direction is a direction other than a predetermined direction, the display image control unit may display the image that urges the user to change the line-of-sight direction to the predetermined direction on the image display unit as the associated display image. According to this type of head mounted display device, it is possible to notify the user of the action to be performed based on the detected action situation. Therefore, the usability to the user is improved.

(5) The head mounted display device according to the aspect may further include a situation detection unit that detects a brightness of the outside scene. In a case where the action situation is the predetermined situation and the detected brightness of the outside scene is equal to or higher than a predetermined brightness set in advance, the function determination unit may set the brightness to be higher than the brightness of the image displayed on the image display unit in a case where the detected brightness of the outside scene is lower than the predetermined brightness. According to this type of head mounted display device, since the associated image is displayed in an appropriate brightness according to the brightness of the outside scene, the user can easily and visually recognize the display image.

(6) The head mounted display device according to the aspect may further include a history storage unit that stores a detected past history of the action at a plurality of time points in which the action situation is the predetermined situation. In a case where the action situation is the predetermined situation, at least one of the determination of the function performed by the function determination unit and a display of the associated display image performed by the image display unit may be performed based on a collation result of the history of the action stored in the plurality of time points and the detected action of the user. According to this type of head mounted display device, the past history of the action of each user is collated, and then the associated display image that is different from each other according to the user is displayed on the image display unit. Therefore, an appropriate image is visually recognized by the user and thus, the convenience to the user is improved.

(7) The head mounted display device according to the aspect may further include an information transmission and reception unit that receives information of the action of another user from another device at a plurality of time points in which the action situation is the predetermined situation, in a case where the action situation is the predetermined situation. At least one of the determination of the function performed by the function determination unit and a display of the associated display image performed by the image display unit may be performed based on the collation result of the received action of another user and the detected action of the user. According to this type of head mounted display device, the associated display image after performing the comparison of the user of the head mounted display device and another user is displayed on the image display unit. Therefore, an appropriate image depending on the user is visually recognized, and thus, the convenience to the user is improved.

(8) In the head mounted display device according to the aspect, the imaging unit may detect a specific target set in advance from the outside scenes, and the action situation may be the combination of the detected action and the specific target detected by the imaging unit. According to this type of head mounted display device, the action situation is detected by detecting the specific target. Therefore, it is easy to detect the action situation, and an erroneous operation of detecting a wrong action situation is reduced.

(9) In the head mounted display device according to the aspect, the action detection unit may be formed integrally on the image display unit and may detect the action of the user based on an acceleration of the image display unit. According to this type of head mounted display device, the action detection unit is integrally formed on the image display unit. Therefore, the action detection unit does not need to be mounted on the user as a separate device, and thus, the usability to the user is improved.

(10) In the head mounted display device according to the aspect, the action detection unit may be formed separate from the image display unit and may be mounted on a body of the user, and may detect the action of the user based on an acceleration of a mounted part of the user. According to this type of head mounted display device, it is possible to perform the function control appropriate to the user or the notification of the information according to the position of detecting the acceleration of the user.

(11) The head mounted display device according to the aspect may further include a situation detection unit that detects a situation of the outside scene. In a case where the action situation is the predetermined situation and the detected situation of the outside scene is the predetermined situation, the function determination unit may determine the function associated with the detected situation of the outside scene. According to this type of head mounted display device, the function of the head mounted display device is controlled according to the situation of the outside scene under an appropriate environment. Therefore, the usability to user is improved.

(12) In the head mounted display device according to the aspect, the predetermined situation may be a combination of the image of the outside scene set in advance and the action of the user associated with the image of the outside scene set in advance. According to this type of head mounted display device, the action of the user associated with the detected image is acquired after the image set in advance is detected. Therefore, the burden for the processing of determining the predetermined situation can be suppressed.

Not all of a plurality of configuration elements in each of the above-described aspect of the invention is essential. In order to solve a part or all of the problems described above, or in order to achieve a part or all of the effects described herein, a change, a deletion, a substitution with a new other configuration element, and a partial deletion of the limiting content can appropriately be performed regarding a part of the plurality of configuration elements. In addition, in order to solve a part or all of the problems described above, or in order to achieve a part or all of the effects described herein, by combining a part or all of the technical features included in an aspect of the invention described above with a part or all of the technical features included in another aspect of the invention described above, an independent aspect of the invention can be made.

For example, an aspect of the invention can be implemented as a device that includes one or two or more elements among four elements of the imaging unit, the image display unit, the action detection unit, and the function determination unit. That is, the device may or may not include the imaging unit. In addition, the device may or may not include the image display unit. In addition, the device may or may not include the action detection unit. In addition, the device may or may not include the function determination unit. The imaging unit, for example, may image the outside scene. The image display unit, for example, may be capable of transmitting the outside scene in addition to displaying the image. The action detection unit, for example, may detect the action of the user. The function determination unit, for example, may determine the function that can be executed by the head mounted display device in a case where the action situation which is the combination of the detected action and the imaged outside scene is the predetermined situation. This device, for example, can be implemented as the head mounted display device, but can also be implemented as another device other than the head mounted display device. According to the aspect like this, it is possible to solve at least one of the various objects such as an improvement and simplification of the operability of the device, an integration of the device, and an improvement of the convenience of the user using the device. Any of the above-described part or all of the technical features in each aspect of the head mounted display device can be applied to this device.

The invention can be implemented in various forms other than the head mounted display device. For example, the invention can be implemented in the forms of: the control method for head mounted display, the information system that includes the head mounted display device, the computer program for implementing the control method for head mounted display device and the information system, the storage medium that stores the computer program, a data signal incorporated in a carrier wave in which the computer program is included, or the like.

### BRIEF DESCRIPTION OF THE DRAWINGS

The invention will be described with reference to the accompanying drawings, wherein like numbers reference like elements.

FIG. 1 is an explanatory diagram illustrating a schematic configuration of the information system in embodiments of the invention.

FIG. 2 is a block diagram functionally illustrating a configuration of a server.

FIG. 3 is a table illustrating an example of traffic information stored in the traffic information in the server.

FIG. 4 is a block diagram functionally illustrating a configuration of the HMD.

FIG. 5 is an explanatory diagram illustrating a state in which an image light is emitted by an image light generation unit.

FIG. 6 is a flowchart for information notification processing.

FIG. 7 is a flowchart for information notification processing.

FIG. 8 is an explanatory diagram illustrating a captured image in a state in which a scene is specified.

FIG. 9 is an explanatory diagram illustrating an example of a field of view that can be visually recognized by a user in a case where an attention image is displayed on the image display unit.

FIG. 10 is an explanatory diagram illustrating an example of a field of view that can be visually recognized by a user in a case where an attention image is displayed on the image display unit.

FIG. 11 is a schematic diagram of an external configuration of an HMD in a modification example.

FIG. 12 is a schematic diagram illustrating a user mounting the HMD in the modification example.

FIGS. 13A and 13B are explanatory diagrams illustrating the external configuration of the HMD in the modification example.

### DESCRIPTION OF EXEMPLARY EMBODIMENTS

### A. First Embodiment

### A-1. Configuration of an Information System

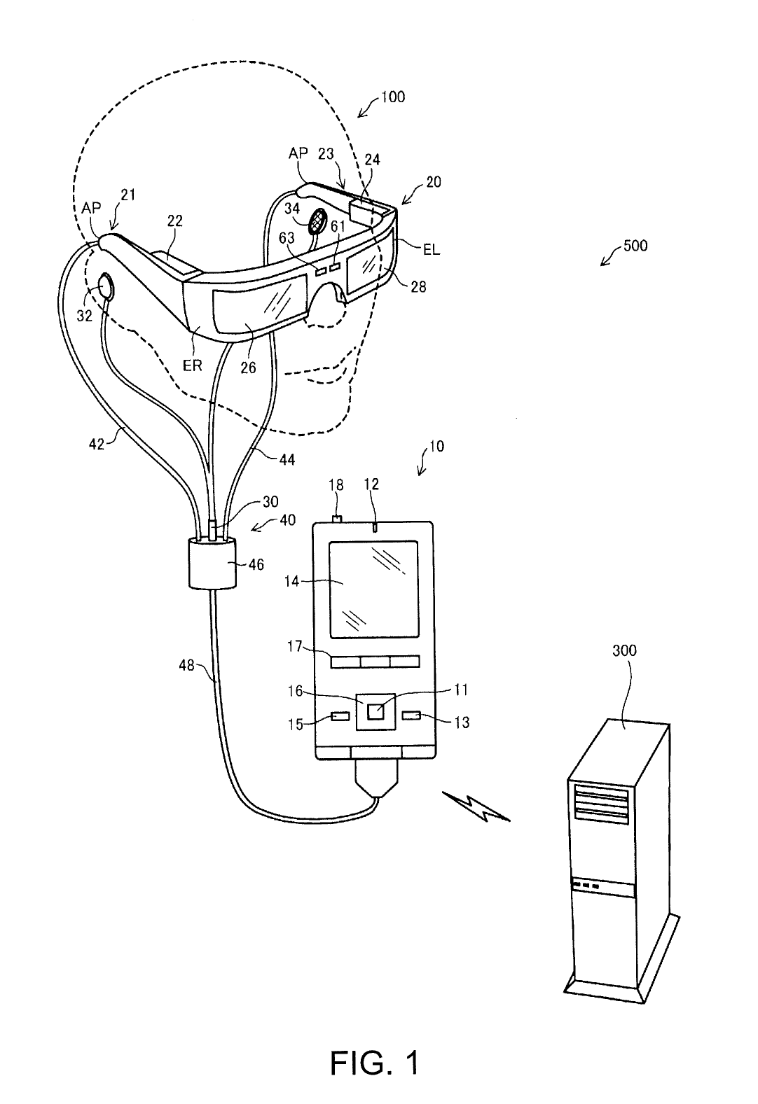

FIG. 1 is an explanatory diagram illustrating a schematic configuration of an information system 500 in the embodiments of the invention. The information system 500 includes a head mounted display 100 (HMD 100) that is mounted on a head of a user and causes the user to visually recognize a virtual image and a server 300 that transmits various information items to an information terminal such as the HMD 100. In the information system 500, when a scene that is a specific situation is specified by the HMD 100, various information items are transmitted from the server 300 based on the specified scene, and a virtual image associated with the scene and the various information items is generated on an image display unit 20 of the HMD 100. In this description, “an image light is generated by the image display unit 20 based on image data such as content” is simply referred to as “an image is displayed”, and the generated image light is simply referred to as the display image. In the present embodiment, only one of the HMD 100 and the server 300 is respectively included in the information system 500. However, a plurality of HMDs 100 and the servers 300 may be included therein in other embodiments.

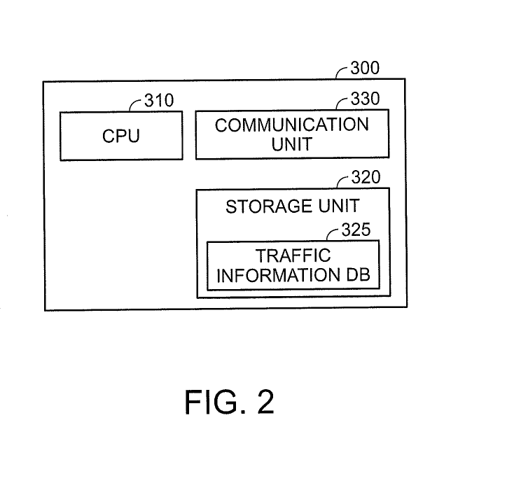

FIG. 2 is a block diagram functionally illustrating a configuration of the server 300. The server 300 includes a storage unit 320 that stores traffic information which is transmitted to the HMD 100, a communication unit 330 that transmits the traffic information stored in the storage unit 320 to the HMD 100, and the CPU 310. The storage unit 320 is configured to include a ROM, RAM, or the like. The storage unit 320 has a traffic information database 325 (traffic information DB 325) in which information on a past traffic accident or information on a traffic restriction due to a construction corresponding to an intersection or a road and notification information notified to the user of the HMD 100 in a case where the HMD 100 satisfies a predetermined condition with respect to the information on the traffic accident or traffic information on the traffic restriction are stored. The details of the traffic information stored in the traffic information IDE 325 will be described below. In addition, the storage unit 320 stores various computer programs.

The communication unit 330 performs wireless communication with other devices in accordance with a predetermined wireless communication method such as a wireless LAN or Bluetooth®. The communication unit 330 transmits and receives various information items between the server 300 and the HMD 100. The CPU 310 reads and executes the computer program stored in the storage unit 320. The CPU 310 selects at least a part of information stored in the traffic information DB 325 based on the scene information or the position information of the HMD 100 received via the communication unit 330. The selected part of the information is referred to as selected traffic information. A method of specifying the position or the like of the image display unit 20 will be described below. The CPU 310 transmits the selected traffic information to the HMD 100 via the communication unit 330. The server 300 in the present embodiment corresponds to an information storage device and the communication unit 330 corresponds to a local information transmission unit in the aspects of the invention. In addition, traffic information TD corresponds to local information in the aspects of the invention.

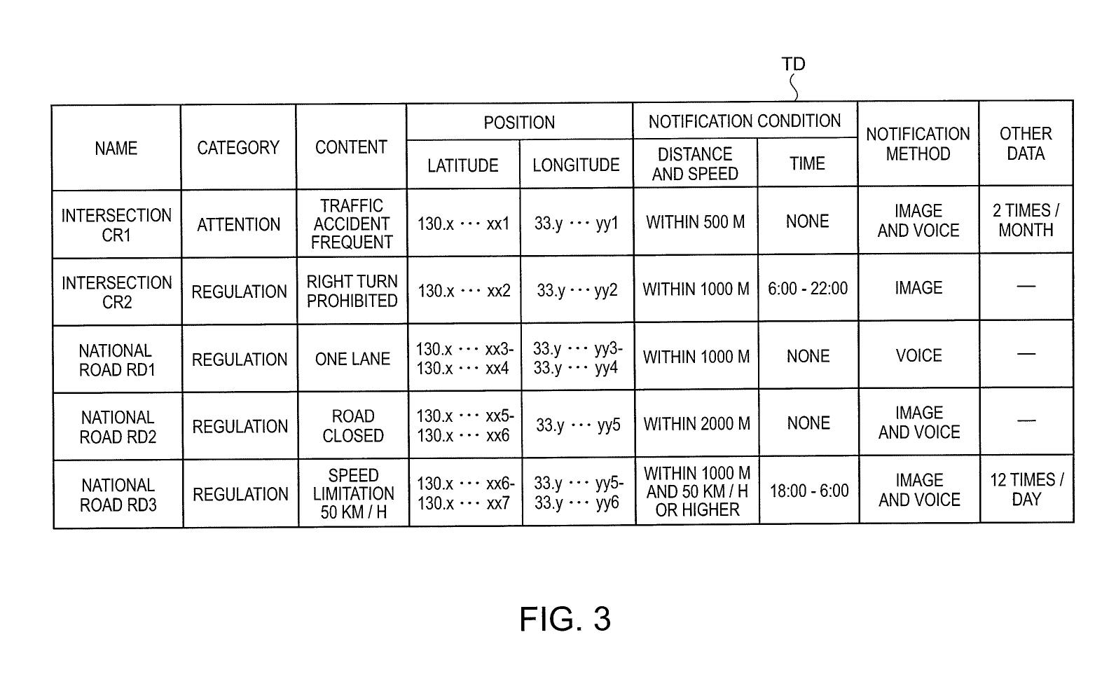

FIG. 3 is a table illustrating an example of the traffic information TD stored in the traffic information DB 325 in the server 300. In FIG. 3, a part of the traffic information TD stored in the traffic information DB 325 is illustrated as a list on an item basis as the information on a past traffic accident or information on a traffic restriction due to a construction corresponding to the intersection, the road, or the like. As illustrated in FIG. 3, the items of the traffic information TD are divided into a name representing the intersection or the road, a category for distinguishing content notified to the user, the content notified to the user, a position of the intersection, the road, or the like, a notification condition for performing the display of the image or the output of the voice, a notification method of notifying the user, and other data indicating the data of another user.

The category is divided into a caution and a regulation. The caution indicates content that urges the user of the HMD 100 to pay attention, and the regulation indicates content that notifies the user of the fact that the traffic is regulated. In the content, the category is further finely classified. For example, the content in the name “intersection CR1” is “a traffic accident frequent spot” to represent the fact that there occur traffic accidents frequently in the intersection CR1. In the same way, the content in the name “intersection CR2” represents the fact that the traffic is regulated such that a right turn is prohibited at the intersection CR2. The content in the name “national road RD1” represents the fact that a traffic in one lane in one direction is regulated on the national road RD1. The content in the name “national road RD2” represents the fact that the national road RD2 is regulated to be closed. The content in the name “national road RD3” represents the fact that the speed limitation is performed on the national road RD3.

In the traffic information TD, for example, the position of the intersection CR1 is stored as the latitude is “130.x . . . xx1” and the longitude is “33.y . . . yy1” . In the same way, the position where traffic in one lane in one direction is regulated on the national road RD1 is stored as the latitude is “from 130.x . . . xx3” to “130.x . . . xx4” and the longitude is “from 33.y . . . yy3 to 33.y . . . yy4”.

The notification condition is divided into an item of distance and speed and an item of time. In a case where both the conditions of the item of distance and speed and the item of time are satisfied, a predetermined notification information is given to the user of the HMD 100. The item of distance and speed represents threshold values of the distance from the HMD 100 to a specific point (for example, to the intersection CR1) and a moving speed of the HMD 100 as the condition for notifying the user of the HMD 100 of the notification information. For example, the threshold values of the distance and the speed on the national road RD3 are the position of the HMD 100 within 1000 m to the national road RD3 and the moving speed of the HMD 100 is equal to or higher than 50 km/h. The item of the time represents the threshold value of the current time as the condition for notifying the user of the HMD 100 of the notification information. For example, the threshold value of the time is the current time between 18:00 to 06:00 on the national road RD3. That is, on the national road RD3, in a case where the distance from the HMD 100 to the national road RD3 is within 1000 m, the moving speed of the HMD 100 is 50 km/h, and in a case where the current time is between 18:00 and 06:00, the notification information associated with the regulation on the national road RD3 is given to the HMD 100.

The item of notification method specifies the combination of the notification method of the image and the voice that is used for notifying the user of the HMD 100 of the notification information. For example, the notification method on the intersection CR1, the national road RD2, and the national road RD3 is the image and the voice, the notification method at the intersection CR2 is only the image, and the notification method on the national road RD1 is only the voice. The item of other data represents past data of a user of the information terminal including another HMD 100 or the like that is different from the user of the HMD 100. For example, in other data at the intersection CR1, the number of traffic accidents occurring at the intersection CR1 in most recent one month is two. In addition, in other data on the national road RD3, twelve vehicles of which the speed exceeds the limit speed of 50 km/h are observed on the national road RD3.

The HMD 100 illustrated in FIG. 1 is an optical transmission type head mounted device with which the user can directly and visually recognize an outside scene when the user visually recognizes a virtual image. The END 100 includes the image display unit 20 that causes the user to visually recognize the virtual image in the state of being mounted on the user's head and a controller 10 that controls the image display unit 20.

The image display unit 20 is a mounting body to be mounted on the user's head and has a glasses shape in this embodiment. The image display unit 20 includes a right holding portion 21, a right display drive unit 22, a left holding portion 23, a left display drive unit 24, a right optical image display unit 26, a left optical image display unit 28, a camera 61, and an illuminance sensor 63. The right optical image display unit 26 and the left optical image display unit 28 are respectively disposed so as to be positioned in front of the right and left eyes of the user when the user wears the image display unit 20. One end of the right optical image display unit 26 and one end of the left optical image display unit 28 are connected to each other at the position corresponding to the position between the eyebrows of the user when the user wears the image display unit 20.

The right holding portion 21 is a member provided to extend from an end portion ER which is the other end of the right optical image display unit 26 to a position corresponding to a side head of the user at the time when the user wears the image display unit 20. Similarly, the left holding portion 23 is a member provided to extend from an end portion EL which is the other end of the left optical image display unit 28 to a position corresponding to a side head of the user at the time when the user wears the image display unit 20. The right holding portion 21 and the left holding portion 23 hold the image display unit 20 on the head of the user in the form of temples of the glasses.

The right display drive unit 22 and the left display drive unit 24 are disposed on the side facing the user's head at the time when the user wears the image display unit 20. Hereinafter, the right holding portion 21 and the left holding portion 23 will be collectively and simply referred to as a “holding portion”, the right display drive unit 22 and the left display drive unit 24 are collectively and simply referred to as a “display drive unit”, and the right optical image display unit 26 and the left optical image display unit 28 are collectively and simply referred to as an “optical image display unit”.

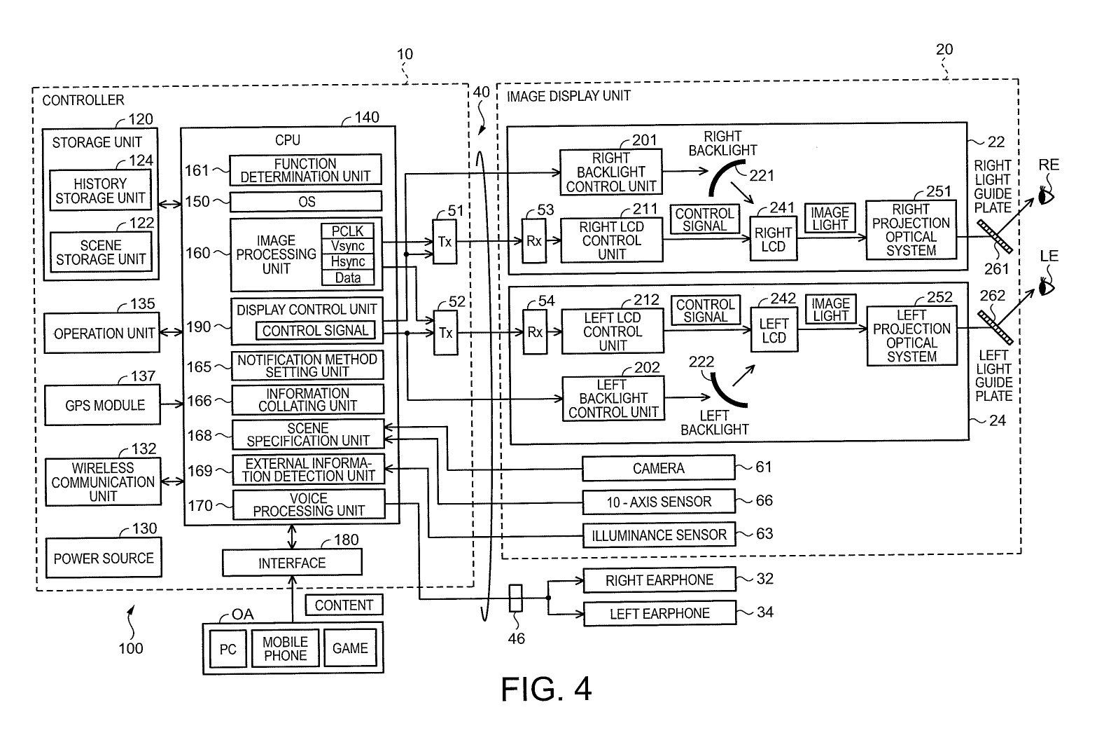

The display drive units 22 and 24 include liquid crystal displays 241 and 242 (hereinafter, referred to as LCDs 241 and 242), projection optical systems 251 and 252, or the like (refer to FIG. 4). Detailed configurations of the display drive units 22 and 24 will be described below. Optical image display units 26 and 28, as optical members include light guide plates 261 and 262 (refer to FIG. 4) and a dimming plate. The light guide plates 261 and 262 are formed of a optically transmissive resin material or the like, and guide the image light output from the display drive units 22 and 24 to the eyes of the user. The dimming plate is a thin plate-shaped optical element and is disposed so as to cover the surface side of the image display unit 20 which is a side opposite to the user's eyes. The dimming plate protects the light guide plates 261 and 262 and suppresses the damage of the light guide plates 261 and 262 or the adhesion of dirt, or the like. In addition, by adjusting the light transmittance of the dimming plate, the amount of external light that enters the user's eyes can be adjusted and then, the ease of the visual recognition of the virtual image can be adjusted. The dimming plate can be omitted.

The camera 61 is disposed at the position corresponding to the position between the eyebrows of the user at the time when the user wears the image display unit 20.

Therefore, the camera 61 images the outside scene which is a scene outside the line-of-sight direction of the user and acquires the captured image in the state in which the user wears the image display unit 20 on his head. The camera 61 in the present embodiment is set to the angle of view that is substantially the same as the field of view of the user. The camera 61 is a monocular camera, but may be a stereo camera. The illuminance sensor 63 is disposed at the position corresponding to the position between the eyebrows of the user at the time when the user wears the image display unit 20 as similar to the camera 61. The illuminance sensor 63 detects an outside scene illuminance which is the scene outside the line-of-sight direction of the user as an index value of the brightness of the outside scene. In another embodiment, the brightness of the outside scene to be detected is not limited to the illuminance, but may be the luminosity or the brightness of the light.

The image display unit 20 further includes a connection portion 40 that connects the image display unit 20 to the controller 10. The connection portion 40 includes a main body cord 48 connected to the controller 10, a right cord 42, a left cord 44, and a connection member 46. The right cord 42 and the left cord 44 are cords in which the main body cord 48 is branched into two. The right cord 42 is inserted into a housing of the right holding portion 21 from a distal portion AP in the extending direction of the right holding portion 21, and is connected to the right display drive unit 22. Similarly, the left cord 44 is inserted into a housing of the left holding portion 23 from a distal portion AP in the extending direction of the left holding portion 23, and is connected to the left display drive unit 24. The connection member 46 is provided on the branch point of the main body cord 48 and the right cord 42 and the left cord 44, and has a jack for connecting an earphone plug 30. A right earphone 32 and a left earphone 34 extend from the earphone plug 30.

The image display unit 20 and the controller 10 perform the transmission of various signals via the connection portion 40. To each of the end portion on the opposite side of the connection member 46 in the main body cord 48 and the controller 10, connectors (not illustrated) fitted to each other are provided. The controller 10 and the image display unit 20 are connected to or separated from each other by fitting or releasing the connector of the main body cord 48 to/from the connector of the controller 10. For example, as the right cord 42, the left cord 44, and the main body cord 48, a metal cable or an optical fiber can be adopted.

The controller 10 is a device for controlling the HMD 100. The controller 10 includes a determination key 11, a lighting unit 12, a display switching key 13, a track pad 14, a brightness switching key 15, a direction key 16, a menu key 17, and a power switch 18. The determination key 11 detects a pressing operation and outputs a signal that determines the content operated in the controller 10. The lighting unit 12 notifies of the operation state of the HMD 100 according to the light emitting state thereof. For example, the power ON or OFF state or the like is the operation state of the HMD 100. For example, a LED is used as the lighting unit 12. The display switching key 13 detects the pressing operation, and for example, outputs a signal that switches display modes of the content moving picture to and from the 3D and 2D. The track pad 14 detects the operation of the user's finger on the operation surface of the track pad 14, and outputs a signal that corresponds to the detected content. Various types of a track pad such as an electrostatic type, pressure sensing type, or an optical type can be adopted as the track pad 14. The brightness switching key 15 detects the pressing operation and outputs a signal that increases or decreases the brightness of the image display unit 20. The direction key 16 detects the pressing operation on the key corresponding to the up, down, right, and left directions, and outputs a signal that corresponds to the detected content. The power switch 18 switches the power-on state of the HMD 100 by detecting a sliding operation of the switch.

FIG. 4 is a block diagram functionally illustrating a configuration of the HMD 100. As illustrated in FIG. 4, the controller 10 includes a storage unit 120, a power source 130, a GPS module 137, a wireless communication unit 132, an operation unit 135, a CPU 140, an interface 180, a transmission unit 51 (Tx 51), and a transmission unit 52 (Tx 52).

The GPS module 137 specifies the current position of the image display unit 20 by receiving a signal from the GPS satellite and generates position information indicating the position of the image display unit 20. In other words, the GPS module 137 specifies the position of the HMD 100 including the image display unit 20. By specifying the current position of the image display unit 20, the current position of the user who wears the HMD 100 is specified. The GPS module 137 corresponds to a position specification unit in the aspects of the invention.

The wireless communication unit 132 performs wireless communication with other devices in accordance with a predetermined wireless communication method such as a wireless LAN or the Bluetooth®. The wireless communication unit 132 transmits the position information of the image display unit 20 specified by the GPS module 137 to the communication unit 330 of the server 300. When the position information of the image display unit 20 is received, the communication unit 330 transmits selected traffic information corresponding to the combination of the specified scene described below and a range of a predetermined distance from the current position of the image display unit 20 (for example, 3000 m) to the wireless communication unit 132 of the HMD 100. The wireless communication unit 132 receives the selected traffic information transmitted from the communication unit 330. The power source 130 supplies the power to each unit of the HMD 100. For example, a secondary battery can be used as the power source 130. The wireless communication unit 132 corresponds to an information transmission and reception unit in the aspects of the invention.

The storage unit 120 stores various computer programs. The storage unit 120 is configured to include a ROM, a ROM, or the like. The storage unit 120 includes a scene storage unit 122 and a history storage unit 124. The scene storage unit 122 stores a plurality of scenes which are the notification conditions to the user in association with the notification information included in the selected traffic information received via the wireless communication unit 132. The scene storage unit 122 stores a plurality of scenes such as a driving state of the user of the HMD 100 or the travelling state. The scene storage unit 122 stores a scene image and a scene state of a specific scene in association with each other. As one scene among the plurality of scenes, the combination of a scene image in which the user specified from the image captured by the camera 61 grasps the steering wheel of the vehicle and a scene state which is an acceleration during the travelling of the vehicle detected by a below-described 10-axis sensor 66 mounted on the image display unit 20, can be exemplified. The scene storage unit 122 stores the scene together with the functions controlled in the HMD 100 for each scene.

The history storage unit 124 stores the past history of each scene stored in the scene storage unit 122. For example, in a case where once the notification information of the regulation of the speed limitation on the national road RD3 (FIG. 3) was notified in the past, the history storage unit 124 stores the date or the like of the notification.

The CPU 140 (FIG. 4) functions as an operating system 150 (OS 150), a display control unit 190, a voice processing unit 170, an image processing unit 160, an external information detection unit 169, a scene specification unit 168, an information collating unit 166, a function determination unit 161, and a notification method setting unit 165 by reading and executing the computer program stored in the storage unit 120.

The display control unit 190 generates a control signal that controls the right display drive unit 22 and the left display drive unit 24. Specifically, the display control unit 190 individually controls a drive ON/OFF of the right LCD 241 by a right LCD control unit 211, the drive ON/OFF of a right backlight 221 by a right backlight control unit 201, the drive ON/OFF of the left LCD 242 by a left LCD control unit 212, the drive ON/OFF of the left backlight 222 by a left backlight control unit 202 or the like, using the control signal. In this way, the display control unit 190 controls the generation and emission of the image light by each of the right display drive unit 22 and the left display drive unit 24. For example, the display control unit 190 causes both of the right display drive unit 22 and the left display drive unit 24 to generate the image light, causes only one of the display drive unit to generate the image light, or causes both of the display drive units not to generate the image light.

The display control unit 190 transmits each control signal for the right LCD control unit 211 and the left LCD control unit 212 via the transmission unit 51 and the transmission unit 52, respectively. In addition, the display control unit 190 transmits each control signal for the right backlight control unit 201 and the left backlight control unit 202.

The image processing unit 160 acquires the image signal included in the content. The image processing unit 160 separates synchronization signals such as a vertical synchronization signal VSync and a horizontal synchronization signal HSync or the like from the acquired image signal. In addition, the image processing unit 160 generates a clock signal PCLK using a phase locked loop (PLL) circuit (not illustrated) or the like according to the cycle of the separated vertical synchronization signal VSync and the horizontal synchronization signal HSync. The image processing unit 160 converts an analog image signal from which the synchronization signal is separated to a digital image signal using an A/D conversion circuit or the like (not illustrated). Then, the image processing unit 160 stores the digital image signal after conversion in a DRAM in the storage unit 120 on a frame basis as the image data (RGB data) of a target image. The image processing unit 160 may execute image processing tasks such as various tone correction processing tasks such as resolution conversion processing and adjustment of the brightness and the saturation, and keystone correction processing with respect to the image data, if necessary.

The image processing unit 160 transmits each of the generated clock signal PCLK, the vertical synchronization signal Vsync, the horizontal synchronization signal Hsync, the image data stored in the DRAM in the storage unit 120 via the transmission unit 51, and the transmission unit 52. The image data transmitted via the transmission unit 51 is referred to as “image data for the right eye” and the image data transmitted via the transmission unit 52 is referred to as “image data for the left eye”. The transmission unit 51 and the transmission unit 52 function as a transceiver for a serial transmission between the controller 10 and the image display unit 20.

The voice processing unit 170 acquires a voice signal included in the content, amplifies the acquired voice signal, and supplies the signal to a speaker (not illustrated) in the right earphone 32 and a speaker (not illustrated) in the left earphone 34 connected to the connection member 46. The voice processing unit 170 outputs the voice based on the notification information included in the selected traffic information. For example, the voice processing unit 170 reads a character image included in the image displayed on the image display unit 20 or outputs an alarm which urges the user to pay attention. For example, in a case where Dolby® system is adopted, processing is performed on the voice signal and the different sounds of which, for example, the frequency or the like is changed are output from each of the right earphone 32 and the left earphone 34.

Using pattern matching or a statistical identification method, the scene specification unit 168 detects the scene image which is associated with the scene stored in the scene storage unit 122 among the captured images captured by the camera 61. In addition, as the scene state, the scene specification unit 168 specifies the moving state (for example, travelling in the vehicle) of the user who wears the image display unit 20 based on the acceleration of the image display unit 20 detected by the below-described 10-axis sensor 66. The scene specification unit 168 detects the scene image, and specifies one scene stored in the scene storage unit 122 in a case where the scene state which is associated with the detected scene image is detected. In other words, the scene specification unit 168 specifies one scene in a case where the combination of the scene image and the scene state is a specific combination. The details of specifying the scene and the notification information associated with the specified scene will be described in the information notification processing. The scene specification unit 168 and the below-described 10-axis sensor 66 correspond to an action detection unit in the aspects of the invention, and the combination of the scene image and the scene state corresponds to an action situation in the aspects of the invention.

The external information detection unit 169 compares the outside scene illuminance detected by the illuminance sensor 63 and threshold values of the illuminance set in advance. As a result of the comparison, in a case where the illuminance is higher than a first threshold value, the external information detection unit 169 raises the brightness of below described backlight 221 and backlight 222 of the image display unit 20, and in a case where the illuminance is lower than a second threshold value, the external information detection unit 169 lowers the brightness of the backlight 221 and the backlight 222. The illuminance sensor 63 and the external information detection unit 169 correspond to a situation detection unit in the aspects of the invention.

When the scene stored in the scene storage unit 122 is specified, the function determination unit 161 determines a part of functions of the HMD 100 stored in the scene storage unit 122 in association with the specified scene. For example, in a case where the specified scene is a scene in which the user of the HMD 100 is driving a vehicle, the function determination unit 161 makes a determination to control to limit apart of the function of displaying the image such that the moving picture, the image of the content or the like is displayed on the image display unit 20. The determination of controlling the function in this description includes the control for the effect of the function to be OFF.

The information collating unit 166 collates the scene specified by the scene specification unit 168 and other data (FIG. 3) in the past history of the scene specified and stored in the history storage unit 124 and the traffic information TD included in the selected traffic information transmitted from the server 300. The information collating unit 166 determines a method of notification performed to the user of the HMD 100 based on the result of the collation.

The notification method setting unit 165 sets the display image to be displayed on the image display unit 20 and a display mode for the display image based on the notification information corresponding to the scene specified and included in the selected traffic information transmitted from the server 300 and the notification method determined by the information collating unit 166. Details of the image displayed on the image display unit 20 will be described in the below-described information notification processing. The notification method setting unit 165 corresponds to a display image control unit in the aspects of the invention.

The operation unit 135 is configured to include the determination key 11, the display switching key 13, the track pad 14, the brightness switching key 15, the direction key 16, the menu key 17, and the power switch 18 that receive physical operations by the user.

The interface 180 is an interface for connecting various external devices OA which are the supply sources of the content to the controller 10. As the external devices OA, a personal computer (PC), a mobile phone terminal, a game terminal, or the like can be exemplified. As the interface 180, for example, a UDB interface, a micro UDB interface, an interface for a memory card, or the like can be used.

The image display unit 20 includes the right display drive unit 22, the left display drive unit 24, the right light guide plate 261 as the right optical image display unit 26, the left light guide plate 262 as the left optical image display unit 28, the camera 61, the illuminance sensor 63, and the 10-axis sensor 66.

The right display drive unit 22 includes a reception unit 53 (Rx 53), the right backlight control unit 201 (right BL control unit 201) and the right backlight 221 (right BL 221) that function as light sources, and the right LCD control unit 211 and the right LCD 241 that function as display devices, and the right projection optical system 251. The right backlight control unit 201 and the right backlight 221 function as light sources. The right LCD control unit 211 and the right LCD 241 function as display devices.

The reception unit 53 functions as a receiver for the serial transmission between the controller 10 and the image display unit 20. The right backlight control unit 201 drives the right backlight 221 based on the input control signal. The right backlight 221 is, for example, a light emitting device such as the LED or an electroluminescence (EL). The right LCD control unit 211 drives the right LCD 241 based on the clock signal PCLK input via the reception unit 53, the vertical synchronization signal Vsync, the horizontal synchronization signal Hsync, and image data for the right eye. The right LCD 241 is a transmission type liquid crystal panel on which a plurality of pixels is arrayed in a matrix shape.

The right projection optical system 251 is configured to include a collimator lens that makes the image light emitted from the right LCD 241 become a light flux of parallel state. The right light guide plate 261 as the right optical image display unit 26 guides the image light emitted from the right projection optical system 251 to the right eye RE of the user while being reflected along a predetermined optical path.

The left display drive unit 24 has a configuration similar to that of the right display drive unit 22. The left display drive unit 24 includes a reception unit 54 (Rx 54), the left backlight control unit 202 (left BL control unit 202) and the left backlight 222 (left BL 222) that function as light sources, the left LCD control unit 212 and the left LCD 242 that function as display devices, and a left projection optical system 252. The left backlight control unit 202 and the left backlight 222 function as light sources. The left LCD control unit 212 and the left LCD 242 function as display devices. The left backlight control unit 202, the left LCD control unit 212, the left backlight 222, and the left LCD 242 are collectively referred to as an “image light generation unit”. In addition, the left projection optical system 252 is configured to include the collimator lens that makes the image light emitted from the left LCD 242 become a light flux of parallel state. The left light guide plate 262 as the left optical image display unit 28 guides the image light emitted from the left projection optical system 252 to the left eye LE of the user while being reflected along the predetermined optical path. The left projection optical system 252 and the left light guide plate 262 are collectively referred to as a “light guide unit”.

The 10-axis sensor 66 is a sensor that detects an acceleration (3 axes), an angle velocity (3 axes), a geomagnetism (3 axes), and an atmospheric pressure (1 axis). The 10-axis sensor 66 is incorporated near the right display drive unit 22 in the image display unit 20, and detects the movement or the position of the user's head when the image display unit 20 is mounted on the user's head.

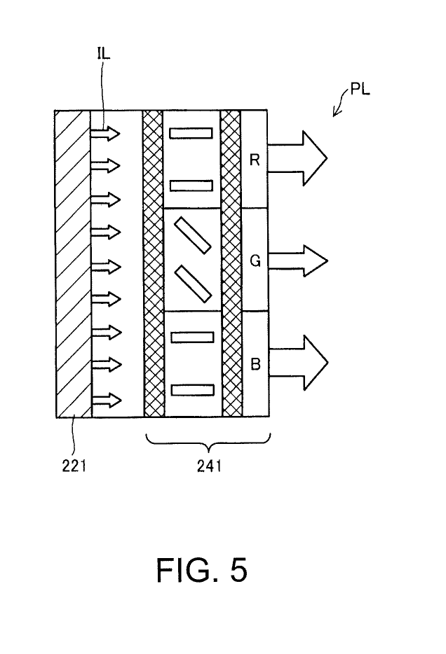

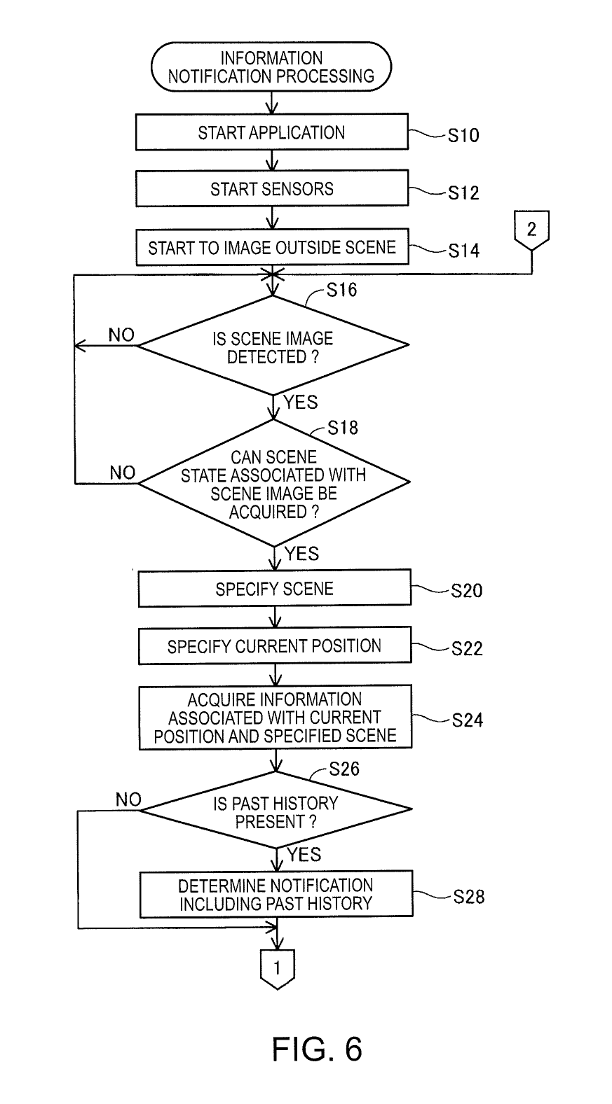

FIG. 5 is an explanatory diagram illustrating a state in which an image light is emitted by the image light generation unit. The right LCD 241 changes the transmittance of the light transmitting the right LCD 241 by driving the liquid crystal at each pixel position arrayed in the matrix shape. As a result, the illumination light IL emitted from the right backlight 221 is modulated to an effective image light PL representing the image. The state in the left side is similar to that in the right side. As illustrated in FIG. 6, the backlight type is adopted in the present embodiment. However, the image light may be emitted using a configuration of front light type or a reflection type.

### A-2. Information Notification Processing

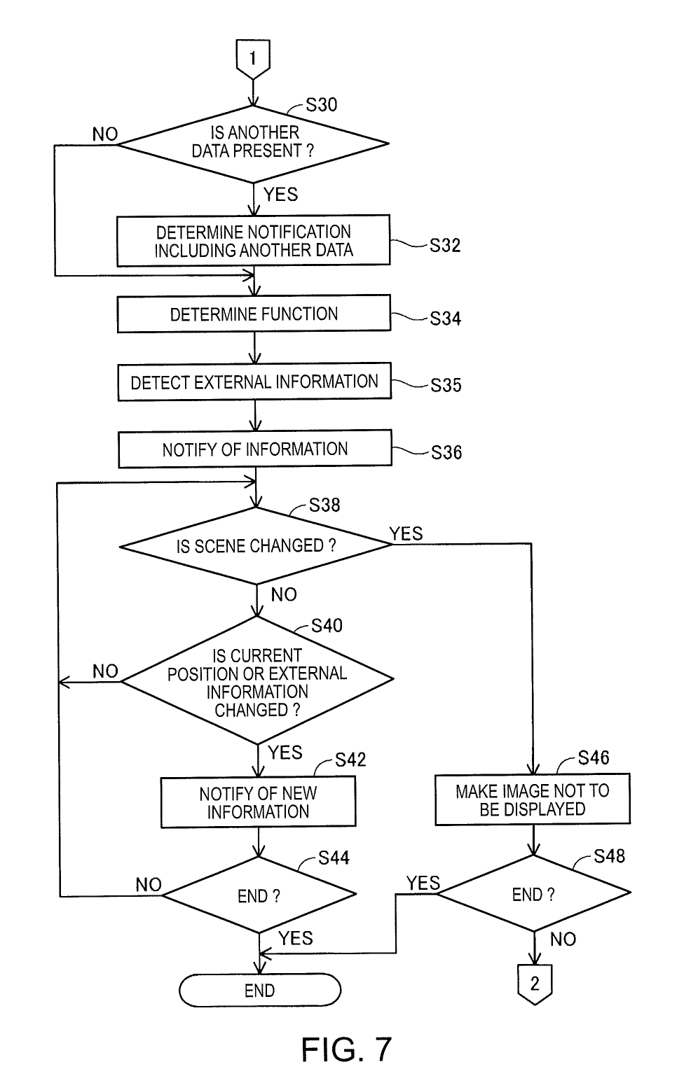

FIG. 6 and FIG. 7 are flowcharts for information notification processing. The information notification processing is processing in which the notification of information associated with the specified scene is given to the user of the HMD 100 by at least one of the means of the voice and the image by the controller 10. Firstly, when the operation unit 135 receives a predetermined processing for starting the information notification processing, the CPU 140 of the controller 10 starts an application for the information notification processing (STEP S10 in FIG. 6). Next, the controller 10 starts various sensors such as the camera 61 that are necessary for performing the information notification processing (STEP S12).

Next, the started camera 61 images the outside scene in the line-of-sight direction of the user who wears the image display unit 20 (STEP S14). The scene specification unit 168 detects the same image as the scene image stored in the scene storage unit 122 (hereinafter, simply referred to as the “scene image”) from the images captured by the camera 61 (STEP S16). In a case where the scene image is not detected (NO in STEP S16), the scene specification unit 168 continuously waits for the detection of the scene image from the captured images (STEP S16). In the processing in STEP S16, in a case where the scene image is detected from the captured images (YES in STEP S16), the scene specification unit 168 determines whether or not the scene state stored in the scene storage unit 122 in association with the detected scene image can be acquired (STEP S18). In a case where the scene state associated with the detected scene image cannot be acquired (NO in STEP S18), the scene specification unit 168 repeats the processing subsequent to STEP S16. In the processing in STEP S18, in a case where the scene state associated with the detected scene image can be acquired (YES in STEP S18), the scene specification unit 168 specifies the detected scene image and the scene stored in association with the acquired scene state.

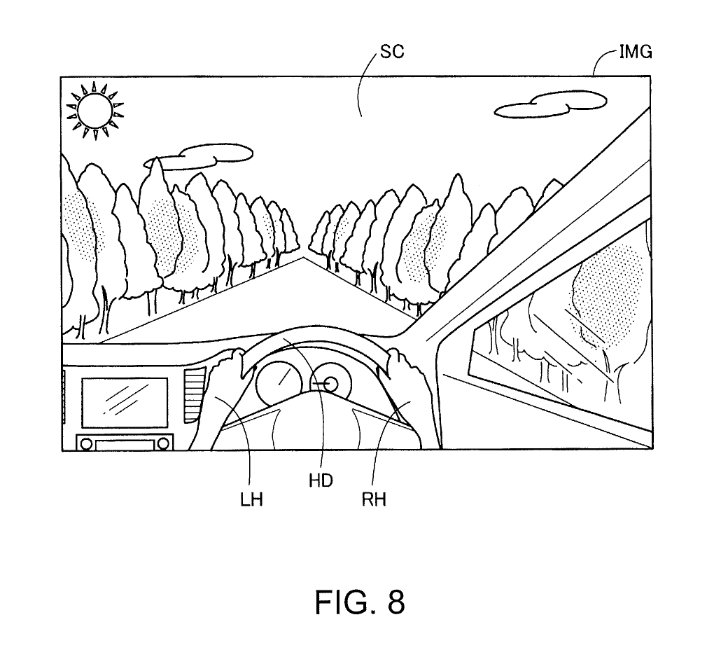

FIG. 8 is an explanatory diagram illustrating a captured image IMG in a state in which a scene is specified. In FIG. 8, as the specified scene, the captured image IMG of the driving state in which the user of the HMD 100 is driving a vehicle is illustrated. As illustrated in FIG. 8, the camera 61 images the outside scene SC as the captured image IMG. In the outside scene SC, a steering wheel HD of the vehicle driven by the user of the HMD 100 and the right hand RH and left hand LH of the user grasping the steering wheel HD are included. The scene storage unit 122 stores the image of the right hand RH and the left hand LF grasping a predetermined position of the steering wheel HD as the scene image of the scene in the driving state. In addition, the scene storage unit 122 stores an acceleration pattern detected by the 10-axis sensor 66 when the user is in the travelling vehicle as the scene state associated with the scene image in the driving state. The scene specification unit 168 detects the right hand RH and left hand LH grasping the predetermined position of the steering wheel HD from the captured image IMG, and specifies that the state of the user of the HMD 100 is the scene of the driving state when the acceleration as the scene state of the driving state is detected. The right hand RH and left hand LH grasping the steering wheel HD correspond to a specific target in the aspects of the invention.

In the processing in STEP S20 in FIG. 6, when the scene is specified, the GPS module 137 specifies the current position of the image display unit 20 (STEP S22). Next, the information collating unit 166 acquires the information corresponding to the current position of the image display unit 20 and the specified scene via the wireless communication unit 132 from the server 300 (STEP S24). Specifically, the information collating unit 166 requests the server 300 via the wireless communication unit 132 to transmit the selected traffic information which is selected as existing within a range of predetermined distance (for example, 3000 m) from the specified position of image display unit 20 in the traffic information TD stored in the traffic information DB 325 of the server 300. The CPU 310 of the server 300 receives the request transmitted from the HMD 100 via the communication unit 330, and transmits the relevant information from the traffic information TD stored in the traffic information DB 325 of the storage unit 320 to the HMD 100 as the selected traffic information. The information collating unit 166 of the HMD 100 receives and acquires the selected traffic information received from the server 300 via the wireless communication unit 132.

When the selected traffic information is acquired, the information collating unit 166 determines whether or not the past history of the user (hereinafter, simply referred to as the “past history”) corresponding to the location in the information included in the acquired selected traffic information is present in the history storage unit 124 (STEP S26). In a case where the past history is determined to be present (YES in STEP S26), the information collating unit 166 makes a determination to perform the notification of the traffic information, including the content in which the past history is added, to the user of the HMD 100 (STEP S28). In a case where the notification including the past history is determined to be performed or it is determined that the past history is not present in the processing in STEP S26 (NO in STEP S26), the information collating unit 166 determines whether or not other data (FIG. 3) which is the past data of a user of another information terminal is present in the acquired selected traffic information (STEP S30 in FIG. 7). In a case where it is determined that other data is present (YES in STEP S30), the information collating unit 166 makes a determination to perform the notification of the traffic information including the content in which other data is added, to the user of the HMD 100 (STEP S32). In a case where the notification including other data is determined to be performed or it is determined that the other data is not present in the processing in STEP S30 (NO in STEP S30), the function determination unit 161 determines the function to be executed in the HMD 100 stored in the scene storage unit 122 in association with the specified scene (STEP S34). Next, the external information detection unit 169 detects the outside scene illuminance as the external information using the illuminance sensor 63 (STEP S35). The external information detection unit 169 sets the brightness of the BL 221 and the BL 222 in a case of displaying the image on the image display unit 20 by comparing the detected outside scene illuminance and the first threshold value and the second threshold value. Then, the notification method setting unit 165 notifies the user of the HMD 100 of the information using the image display unit 20 and the earphones 32 and 34 based on the selected traffic information, the notification method determined by the information collating unit 166, and the brightness of the BL 221 and BL 222 set by the external information detection unit 169 (STEP S36).

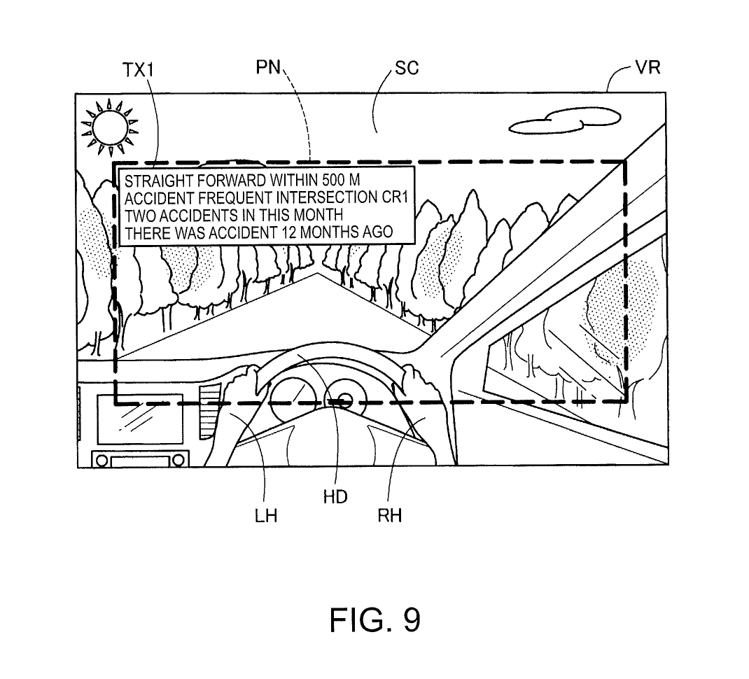

FIG. 9 is an explanatory diagram illustrating an example of a field of view VR that can be visually recognized by the user in a case where an attention image TX1 is displayed on the image display unit 20. As illustrated in FIG. 9, unlike the captured image IMG in FIG. 8, in addition to the outside scene SC, the user visually recognizes the attention image TX1 displayed on the optical image display units 26 and 28 of the image display unit 20 so as to be superimposed on the outside scene SC. In FIG. 9, an image display maximum area PN that is the maximum area in which the image can be displayed on the optical image display units 26 and 28 and that is not visually recognized by the user is indicated in a dashed line. The attention image TX1 is a character image displayed on the image display maximum area PN based on the information corresponding to the intersection CR1 in the traffic information TD (FIG. 3). The attention image TX1 is a character image formed by four lines of text. The first line of the attention image TX1 represents how the position of the intersection CR1 is away from the position of the user. The second line of the attention image TX1 represents the character of “frequent accident” that urges the user to pay attention in the intersection CR1, and the name of the intersection CR1. The third line of the attention image TX1 represents the information of another user corresponding to other data (FIG. 3) at the intersection CR1 in the traffic information TD, and represents that the number of accidents in this month at the intersection CR1 is two. The fourth line of the attention image TX1 represents the past history of the user of the HMD 100 at the intersection CR1 stored in the history storage unit 124, and represents that the user has an experience of causing an accident at the intersection CR1 twelve months ago. The third line of the attention image TX1 is a character image associated with the notification including other data in the processing in STEP S32 in FIG. 7, and the fourth line of the attention image TX1 is a character image associated with the notification including past history in the processing in STEP S28 in FIG. 6. Therefore, the character images in the third and fourth lines of the attention image TX1 are the images in which the presence or absence of the display or the display content is different according to the user of the HMD 100.

In addition, as illustrated in the traffic information TD (FIG. 3), the notification method of the intersection CR1 includes the notification by voice given to the user in addition to the image. Therefore, the notification method setting unit 165 displays the attention image TX1 on the image display maximum area PN and outputs the voice urging the user to pay attention via the earphones 32 and 34. The voice urging the user to pay attention is the voice reading the character image of the attention image TX1.

In addition to the performing of the notification given to the user by the attention image TX1 and the voice, the function determination unit 161 determines the function associated with specified scene of the driving state. In the present embodiment, the function determination unit 161 determines such a control that the moving picture, the image of the content or the like cannot be displayed on the image display maximum area PN, and displays the image associated with the attention or the regulation of the attention image TX1 or the like on the portion other than the center portion of the image display maximum area PN. The center portion of the image display maximum area PN in the present embodiment means the central area when the rectangular shaped image display maximum area PN is divided into three respective sections in vertical and horizontal (total of nine sections). The center portion of the image display maximum area PN in another embodiment may be a portion different from the above. In addition, the character image may be displayed or the voice may be output, which represents that the area on which the display image is displayed on the attention image TX1 is limited.

In the processing In STEP S36 in FIG. 7, when the notification is given to the user by the attention image TX1 and the voice, the scene specification unit 168 detects the change of the scene (STEP S38). When the change of the specified scene is detected (YES in STEP S38), the notification method setting unit 165 makes the attention image TX1 displayed on the image display maximum area PN not be displayed (STEP S46). Next, the operation unit 135 determines whether or not a predetermined operation to end the information notification processing is received (STEP S48). In a case where it is determined that the predetermined operation is received (YES in STEP S48), the controller 10 ends the information notification processing. In the processing in STEP S48, in a case where it is determined that the predetermined operation is not received (NO in STEP S48), the controller 10 repeats the processing tasks subsequent to STEP S16 in FIG. 6.

In the processing in STEP S38 in FIG. 7, in a case where the change of the scene is not detected (NO in STEP S38), the GPS module 137 detects the change of the current position of the image display unit 20 (STEP S40). In a case where the current position of the image display unit 20 is not changed (NO in STEP S40), the scene specification unit 168 continuously waits for the detection of the change of the scene (STEP S38). In the processing in STEP S40, in a case where the change of the current position of the image display unit 20 is detected (YES in STEP S40), the notification method setting unit 165 notifies the user of the HMD 100 of new information corresponding to the changed current position of the image display unit 20 (STEP S42).

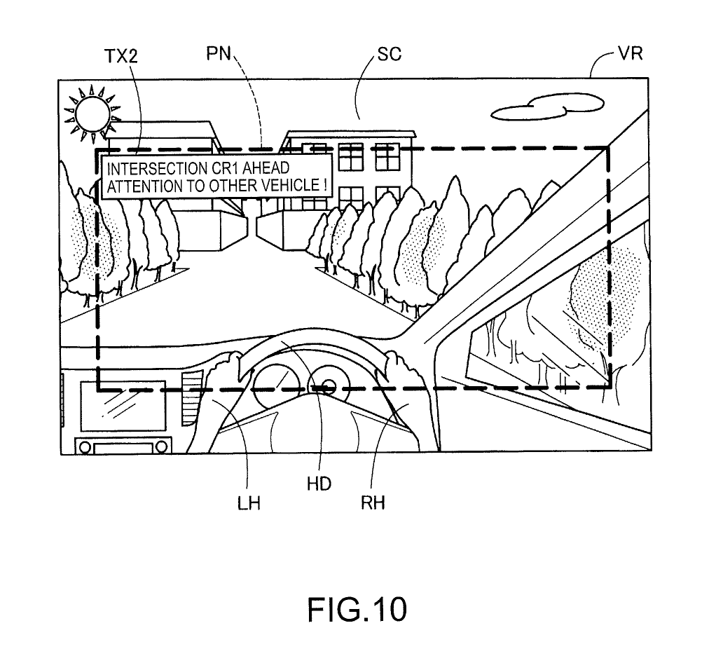

FIG. 10 is an explanatory diagram illustrating an example of a field of view VR that can be visually recognized by the user in a case where an attention image TX2 is displayed on the image display unit 20. In FIG. 10, the field of view VR visually recognized by the user in a case where the current position of the image display unit 20 mounted on the user who is a driver of the vehicle approaches closer to the intersection CR1 than the field of view VR illustrated in FIG. 9, is illustrated. In the present embodiment, in a case where the intersection CR1 exists within a predetermined distance (for example, within 100 m), the notification method setting unit 165 displays the attention image TX2 that does not include the character image associated with other data of the traffic information TD (FIG. 3) and the character image associated with the past history stored in the history storage unit 124 on the image display maximum area PN. As illustrated in FIG. 10, the first line of the attention image TX2 is the character image representing that the immediately previous intersection is the intersection CR1. The second line of the attention image TX2 is a character image representing a specific content urging the user to pay attention. In addition, the notification method setting unit 165 also performs the notification to the user by the voice in addition to the display of the attention image TX2. The notification method setting unit 165 outputs the voice reading the character image of the attention image TX2 via the earphones 32 and 34. The attention image TX1 and the attention image TX2 correspond to an associated display image in the aspects of the invention.

In the processing in STEP S42 in FIG. 7, when the notice of the new information is given to the user, the operation unit 135 determines whether or not a predetermined operation to end the information notification processing is received (STEP S44). In a case where it is determined that the predetermined operation is not received (NO in STEP S44), the controller 10 repeats the processing tasks subsequent to STEP S38. In the processing in STEP S44, in a case where it is determined that the predetermined operation is received (YES in STEP S44), the controller 10 ends the information notification processing.

As described above, in the HMD 100 in the present embodiment, the scene specification unit 168 specifies the scene of the user based on the scene image detected from the images captured by the camera 61 and the scene state detected by the 10-axis sensor 66. In a case where the specified scene is the specific scene stored in the scene storage unit 122, the function determination unit 161 determines the function to be executed in the HMD 100. In the HMD 100 in the present embodiment, since the function of the HMD 100 that is considered not necessary to the user is limited according to the scene of the user regardless of the place, it is possible to provide only the function necessary to the user according to the situation, and thus, the convenience to the user is improved.

In addition, in the HMD 100 in the present embodiment, since the attention image TX1 or the attention image TX2 associated with the scene is displayed on the image display unit 20, the user can visually recognize the information relating to the scene, and thus, the convenience to the user is improved.

In addition, in the HMD 100 in the present embodiment, the wireless communication unit 132 transmits the current position of the image display unit 20 specified by the GPS module 137 to the server 300, and acquires the selected traffic information from the server 300. The notification method setting unit 165 displays the attention images TX1 and TX2 associated with the selected traffic information transmitted from the server 300 on the image display unit 20. Therefore, in the HMD 100 in the present embodiment, since the attention images TX1 and TX2 in which the current position of the image display unit 20 is added in addition to the specified scene are displayed on the image display unit 20, it is possible to cause the user to visually recognize the information which is further necessary for the user, and thus, the usability to the user is improved.

In addition, in the HMD 100 in the present embodiment, the external information detection unit 169 compares the outside scene illuminance detected by the illuminance sensor 63 and the threshold value. In a case where the detected outside scene illuminance is equal to or higher than the first threshold value, the brightness of the BL 221 and the BL 222 of the image display unit 20 is raised in comparison to the case where the outside scene illuminance is lower than the first threshold value. Therefore, in the HMD 100 in the present embodiment, since the image is displayed in an appropriate brightness according to the brightness of the outside scene, the user can easily and visually recognize the display image.

In the HMD 100 in the present embodiment, the external information detection unit 169 collates the specified scene and the past history of the user stored in the history storage unit 124, and the notification method setting unit 165 displays the attention image TX1 associated with the collation result on the image display unit 20. In the HMD 100 in the present embodiment, the past history of each user is collated, and then the attention image TX1 that is different from each other according to the user is displayed on the image display unit 20. Therefore, an appropriate image is visually recognized by the user and thus, the convenience to the user is improved.

In the HMD 100 in the present embodiment, the external information detection unit 169 receives the selected traffic information including the information of another user from the server 300 via the wireless communication unit 132. The external information detection unit 169 collates the specified scene and the information of another user included in the selected traffic information, and the notification method setting unit 165 displays the attention image TX1 associated with a collation result on the image display unit 20. In the HMD 100 in the present embodiment, the attention image TX1 after performing the comparison of the user of the HMD 100 and another user is displayed on the image display unit 20. Therefore, an appropriate image depending on the user is visually recognized, and thus, the convenience to the user is improved.

In addition, in the HMD 100 in the present embodiment, the scene specification unit 168 detects the image of the right hand RH and left hand LH grasping the predetermined position of the steering wheel HD from the image captured by camera 61 as the specific scene image, and specifies the scene in a case where a specific scene state is detected. In the HMD 100 in the present embodiment, a specific image is specified as the scene image by the pattern matching or the like. Therefore, it is easy to specify the scene and an erroneous operation of specifying a wrong scene is reduced.

In addition, in the HMD 100 in the present embodiment, the 10-axis sensor 66 is configured integrally with the image display unit 20. Therefore, the 10-axis sensor 66 that specifies the operation of the user does not need to be mounted on the user as a separate device, and thus, the usability to the user is improved.

In addition, in the HMD 100 in the present embodiment, the scene specification unit 168 acquires the combination of the image the same as the scene image stored in the scene storage unit 122 and the scene state associated with the detected scene image. For this reason, the determination of the scene state associated with the scene image is performed after the scene image is detected. Therefore, the burden for processing of specifying the scene can be suppressed.

### B. Modification Example

The invention is not limited to the embodiment described above and various aspects can be embodied without departing from the spirit thereof. For example, the following modification can also be possible.

### B-1. Modification Example 1

In the embodiment described above, the function of the HMD 100 determined by the function determination unit 161 is displaying the moving picture or the image of the content or the like. However, there may be various modifications in the determined function. For example, the function determination unit 161 may not only determine to display the moving picture or the image of the content or the like but also determine not to display any of the image on the image display maximum area PN, and may determine the volume of the voice output by the earphones 32 and 34. In addition, the function determination unit 161 may store the images captured by the camera 61 and may acquire and store the surrounding voice by a microphone disposed in the image display unit 20 or a separated body.

In a case where the scene is specified as the driving state, the function determination unit 161 may disable the function of calling with another mobile terminal or may start the operation of a navigation application that notifies the user of the traffic guide. When the time is close to noon or the like, the navigation application may notify the user of the information such as a restaurant at which to eat lunch in addition to the route guidance to the destination as the sound or the image. In addition, the function determination unit 161 may start the application that stores and notifies the user of the influence of the long-time driving on the user. In a case where one-hour continuous driving is performed, for example, this application may perform the notification for urging the driver to take a break. In a case where the timing of brakes is late compared to other data (FIG. 3) or the past history of the user, the application may perform the notification for urging the driver to brake earlier or the notification of the appropriate speed on the road of current travelling.

In the embodiment described above, the character image corresponding to the attention or the regulation to the user stored in the traffic information TD is displayed as the attention image TX1 and the attention image TX2 displayed on the image display unit 20, but the notification method setting unit 165 may display the function of which the execution is determined by the function determination unit 161 or may output the controlled function through the voice by the earphones 32 and 34. In addition, in the processing in STEP S46 in the information notification processing in the embodiment described above, the notification method setting unit 165 displays the attention image TX1, but notifies the user of the non-display of the attention image TX1 by the voice. In addition, the notification method setting unit 165 may not display the character image such as the attention image TX1 or the attention image TX2 but may display a moving picture or another image by a graphic or the like on the image display unit 20, or may change the display mode such as font or the size of the characters in the character image according to other data or the like in the past history or the selected traffic information. In addition, the function determination unit 161 may determine the function executed by the HMD 100 based on other data or the like in the past history or the selected traffic information.

In the embodiment described above, the scene specification unit 168 specifies the scene after the scene image is detected (YES in STEP S16 in FIG. 6) in a case where the scene state associated with the scene image is acquired (YES in STEP S18). However, the order of the detection of the scene image and the acquisition of the scene state can be modified variously. After the scene state is detected, the scene specification unit 168 may acquire the scene image associated with the detected scene state. The combination of the scene state and the scene image, including the order of detection, can be modified variously.

In the embodiment described above, the traffic information TD (FIG. 3) is described as an example of the local information. However, the local information can be modified variously. For example, the category in the traffic information TD is not limited to the example illustrated in FIG. 3, and the position information of restaurants, gas stations, or the like may be included in the traffic information TD as well as the information of the regulation or the attention regarding the road or the intersection. In addition, as the local information, not only the traffic information but also the tourist information or the like may be stored in the server 300.

### B-2. Modification Example 2

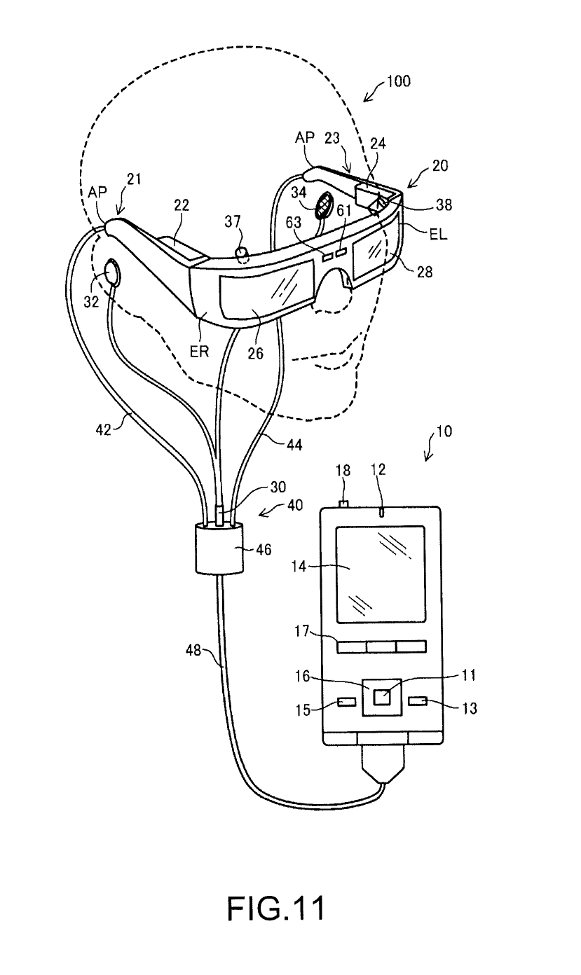

In addition, a right eye imaging unit and a left eye imaging unit that respectively image the right eye and left eye of the user may be disposed in the image display unit 20 in the embodiment described above, and then, the function determination unit 161 may determine to control a part of the function of the HMD 100 based on the right eye image captured by the right eye imaging unit and the left eye image captured by the left eye imaging unit. FIG. 11 is a schematic diagram of an external configuration of an HMD 100a in the modification example. The different point in the configuration in the HMD 100a in the modification example is that a camera of a right eye imaging unit 37 and a camera of a left eye imaging unit 38 are added to the HMD 100 in the embodiment described above, and the other configuration is the same. In this modification example, the scene specification unit 168 specifies the line-of-sight direction of the user by performing an analysis such as the pattern matching on the right eye image of the right eye imaging unit 37 and the left eye image of the left eye imaging unit 38. In a case where the specified scene is the driving state and the specified line-of-sight direction of the user is specified as the direction other than the front direction, the notification method setting unit 165 performs the notification for urging the user to move the line-of-sight direction to the front direction by the voice and the image. In this way, in the HMD 100a in the modification example, it is possible to notify the user of the action to be performed based on the specified scene. Therefore, the usability to the user is improved. The right eye imaging unit 37 and the left eye imaging unit 38 in the HMD 100a and the scene specification unit 168 correspond to the action detection unit and the front direction corresponds to a predetermined direction in the aspect of the invention.

### B-3. Modification Example 3

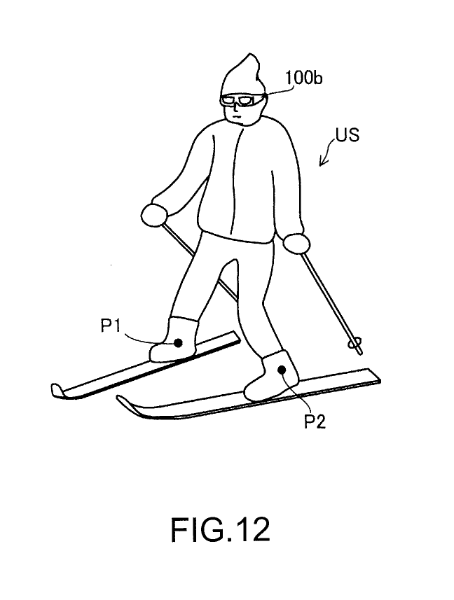

In addition, an acceleration sensor configured separately from the image display unit 20 in the embodiment described above may be mounted to the user, and the scene may be specified by the acceleration of the user detected by the acceleration sensor and the image captured by the camera 61. FIG. 12 is a schematic diagram illustrating a user US mounting the HMD 100b in the modification example. In FIG. 12, the user US who is skiing with the HMD 100b mounted is illustrated. The different point in the configuration in the HMD 100b in this modification example is that the HMD 100b is configured to include a first acceleration sensor P1 and a second acceleration sensor P2 that are separate from the controller 10 and the image display unit 20, and the other configuration is the same. In this modification example, the first acceleration sensor P1 is mounted on the ankle of the right foot of the user US and the second acceleration sensor P2 is mounted on the ankle of the left foot of the user US. The scene specification unit 168 specifies the action of skiing of the user US as the scene of the user using the acceleration of the right foot detected by the first acceleration sensor P1, the acceleration of the left foot detected by the second acceleration sensor P2, and the image captured by the camera 61. The function determination unit 161 starts a lecture application associated with the specified skiing scene. The notification method setting unit 165 displays the image for the lecture associated with the lecture application of skiing on the image display unit 20 and outputs the voice for the lecture to the earphones 32 and 34. In the HMD 100b in this modification example, since the first acceleration sensor P1 and the second acceleration sensor P2 are configured separately from the image display unit 20 mounted on the head of the user US, the acceleration of various parts of the body such as the foot or the arm of the user US can be detected. In this way, it is possible to perform the determination of the function more appropriate to the user or perform the notification of the information according to the part of the body in which the acceleration of the user US is detected. The first acceleration sensor P1 and the second acceleration sensor P2 in this modification example correspond to the action detection unit in the aspect of the invention.

In the HMD 100b in the modification example described above, the determination of the function or the display of the image may be performed in the scene other than the skiing scene. For example, in a case where the specified scene is a running scene, the first acceleration sensor P1 is mounted on the right arm of the user US and the second acceleration sensor P2 is mounted on the left foot of the user US, and then, the image of advice on the desirable swing of both arms, the stance of both feet or the like may be displayed on the image display unit 20. In addition, instead of the first acceleration sensor P1 and the second acceleration sensor P2, the pulse of the user US may be measured. In addition, the HMD 100b may not be necessarily configured of two acceleration sensors such as the first acceleration sensor P1 and the second acceleration sensor P2, but may be configured of one acceleration sensor or may be configured of three or more acceleration sensors.

### B-4. Modification Example 4

In the embodiment described above, the operation unit 135 is formed in the controller 10. However, the aspect of the operation unit 135 can be variously modified. For example, it may be an aspect having a user interface which is the operation unit 135 separate from the controller 10. In this case, since the operation unit 135 is separate from the controller 10 on which the power source 130 or the like is formed, it is possible to miniaturize the size, thereby improving the operability of the user. In addition, the camera 61 is disposed on the image display unit 20. However, the camera 61 may be configured separately from the image display unit 20 so as to be able to capture the outside scene SC. In the HMD 100, both of the CPU 140 and the power source 130 that configure the controller 10 may be mounted on the image display unit 20. In this HMD 100, since there is no controller that is configured separately from the image display unit 20, it is possible to further miniaturize the size. By mounting the CPUs 140 on each of the controller 10 and the image display unit 20, the controller 10 may be used as a single-body controller and the image display unit 20 may be used as a single-body display device.

For example, the image light generation unit may be configured to include an organic electro-luminescence (organic EL) display and an organic EL control unit. In addition, for example, the image light generation unit can use, instead of an LCD, liquid crystal on silicon (LCOS®), a digital micro-mirror device, or the like. In addition, for example, it is also possible to apply the invention to a laser retina projection type HMD 100.

In addition, for example, the HMD 100 may be a head mounted display having an aspect in which an optical image display unit covers only a part of the eyes of the user, in other words, an aspect in which the optical image display unit does not completely cover the eyes of the user. In addition, the HMD 100 may be a so-called monocular type head mounted display. In addition, the HMD 100 is a binocular and optical transmission type. However, the invention can similarly be applied to a head mounted display device of another type such as a video transmission type.

In addition, the HMD 100 may be used as a display device only for displaying an image which is based on an image signal received from another device. Specifically, the HMD 100 may be used as a display device corresponding to a monitor of a desktop type PC. For example, by receiving an image signal from the desktop type PC, the image may be displayed on the image display maximum area PN of the image display unit 20.

In addition, the HMD 100 may be used so as to function as a part of the system. For example, the HMD 100 may be used as a device that executes a part of functions of a system including an aircraft. The system in which the HMD 100 is used is not limited to the system including the aircraft, but may be a system including a vehicle, a bicycle, or the like.

In addition, an ear-hook type earphone or a headband type earphone may be adopted, or the earphone may be omitted. In addition, for example, the head mounted display device may be configured so as to be mounted on a vehicle such as an automobile or an airplane. In addition, for example, the head mounted display device may be configured so as to be built in a body protector such as a helmet.

### B-5. Modification Example 5

The configuration of the HMD 100 in the embodiment described above is only an example and various modifications can be made. For example, the direction key 16 provided on the controller 10 may be omitted or another operational interface such as an operational stick may be provided in addition to the direction key 16 and the track pad 14. In addition, the controller 10 has a configuration such that input devices such as a keyboard or a mouse can be connected. The controller 10 may receive the input from the keyboard or the mouse.

In addition, as an image display unit, instead of the image display unit 20 mounted like eyeglasses, for example, another type of image display unit such as an image display unit that is mounted like a cap may be adopted. In addition, the earphones 32 and 34 can appropriately be omitted.

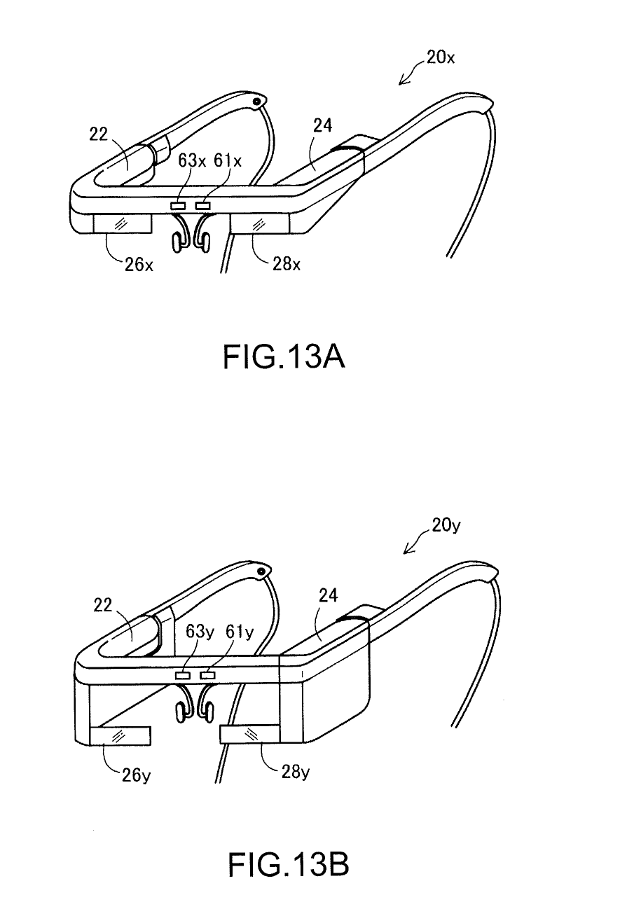

FIGS. 13A and 13B are explanatory diagrams illustrating an external configuration of the HMD in the modification example. In a case of an example in FIG. 13A, the configuration of the HMD in the modification example is different from the HMD 100 illustrated in FIG. 1 in a point that: an image display unit 20x includes a right optical image display unit 26x instead of the right optical image display unit 26, and includes a left optical image display unit 28x instead of the left optical image display unit 28. The right optical image display unit 26x is formed smaller than the optical member in the embodiment described above, and is disposed diagonally upward from the right eye of the user when mounting the HMD 100x. Similarly, the left optical image display unit 28x is formed smaller than the optical member in the embodiment described above, and is disposed diagonally upward from the left eye of the user when mounting the HMD 100x. In a case of an example in FIG. 13B, the configuration of the HMD in the modification example is different from the HMD 100 illustrated in FIG. 1 in a point that: an image display unit 20y includes a right optical image display unit 26y instead of the right optical image display unit 26, and includes a left optical image display unit 28y instead of the left optical image display unit 28. The right optical image display unit 26y is formed smaller than the optical member in the embodiment described above, and is disposed diagonally downward from the right eye of the user when mounting the head mounted display. The left optical image display unit 28y is formed smaller than the optical member in the embodiment described above, and is disposed diagonally downward from the left eye of the user when mounting the head mounted display. In this way, it is sufficient if the optical image display units are disposed in the vicinity of the eyes of the user. In addition, the size of the optical member that forms the optical image display unit is also optional, and thus, it is possible to implement the aspect of the HMD 100 such that the optical image display unit covers only a part of the eyes of the user, in other words, such that the unit does not completely cover the eyes of the user.

In addition, in the embodiment described above, the HMD 100 may guide an image light representing the same images to the right and left eyes of the user such that the user visually recognizes two-dimensional images, or may guide an image light representing the different images to the right and left eyes of the user such that the user visually recognizes three-dimensional images.

In addition, in the embodiment described above, a part of the configuration that is implemented by hardware may be replaced by software, or conversely, a part of the configuration that is implemented by software may be replaced by hardware. For example, in the embodiment described above, the functions of the image processing unit 160 and the voice processing unit 170 are implemented by the CPU 140 reading and executing the computer program. However, these function units may be implemented by a hardware circuit.

In addition, in a case where a part or all of the functions of the invention are implemented by software, the software (computer program) can be provided in the form of being stored in a computer-readable storage medium. In the invention, “the computer-readable storage medium” is not limited to a portable type storage medium such as a flexible disk or CD-ROM but includes an internal storage device in a computer such as various RAM, ROM or the like or an external storage device fixed to the computer such as a hard disk.

In addition, in the embodiment described above, as illustrated in FIG. 1 and FIG. 4, the controller 10 and the image display unit 20 are configured to be separated from each other. However, the configuration of the controller 10 and the image display unit 20 is not limited thereto and various modifications can be made. For example, all of the configurations formed in the controller 10 may be formed in the image display unit 20 or a part thereof may be formed in the image display unit 20. In addition, the power source 130 in the embodiment described above may have a configuration of being independently formed and being replaceable, or the power source 130 may be formed in a duplicated manner in the image display unit 20 in addition to the configuration of being formed in the controller 10. For example, the CPU 140 illustrated in FIG. 2 may be formed on both of the controller 10 and the image display unit 20, or the functions performed by the CPU 140 formed in the controller 10 and the CPU formed in the image display unit 20 may be separately divided.

The invention is not limited to the embodiment and the modification examples described above and can be implemented by various modifications without departing from the spirit of the invention. For example, the technical features in the embodiment and the modification examples corresponding to the technical features in each aspect described in the SUMMARY can appropriately be replaced or combined in order to solve a part or all of the problems described above, or in order to achieve a part or all of the effects described above. In addition, if the technical features are not described as essential herein, the technical features may appropriately be deleted.

The entire disclosure of Japanese Patent Application No. 2014-183284, filed Sep. 9, 2014 is expressly incorporated by reference herein.

What is claimed is:

1. A transmission type head mounted display device comprising:
an imaging unit that images an outside scene;
an image display unit that displays the image and is capable of transmitting the outside scene;
an action detection unit that detects an action of a user; and
a function determination unit that determines a function which can be executed by the head mounted display device in a case where an action situation which is a combination of the detected action and the imaged outside scene is a predetermined situation.

2. The head mounted display device according to claim 1, further comprising:
a display image control unit that displays an associated display image associated with at least one of the determined function and the action situation on the image display unit in a case where the action situation is the predetermined situation.

3. The head mounted display device according to claim 2, further comprising:
a position specification unit that specifies a current position of the image display unit in a case where the action situation is the predetermined situation; and
an information transmission and reception unit that transmits position information representing a specified current position to another device and receives local information which is based on the position information,
wherein the display image control unit displays the image associated with the received local information on the image display unit as the associated display image.

4. The head mounted display device according to claim 2,
wherein the action detection unit detects a line-of-sight direction of the user as the action of the user, and
wherein, in a case where the action situation is the predetermined situation and a detected line-of-sight direction is a direction other than a predetermined direction, the display image control unit displays the image that urges the user to change the line-of-sight direction to the predetermined direction on the image display unit as the associated display image.

5. The head mounted display device according to claim 2, further comprising:
a situation detection unit that detects a brightness of the outside scene,
wherein, in a case where the action situation is the predetermined situation and the detected brightness of the outside scene is equal to or higher than a predetermined brightness set in advance, the function determination unit sets the brightness to be higher than the brightness of the image displayed on the image display unit in a case where the detected brightness of the outside scene is lower than the predetermined brightness.

6. The head mounted display device according to claim 2, further comprising:
a history storage unit that stores a detected past history of the action at a plurality of time points in which the action situation is the predetermined situation,
wherein, in a case where the action situation is the predetermined situation, at least one of the determination of the function performed by the function determination unit and a display of the associated display image performed by the image display unit is performed based on a collation result of the history of the action stored in the plurality of time points and the detected action of the user.

7. The head mounted display device according to claim 2, further comprising:
an information transmission and reception unit that receives information of the action of another user at a plurality of time points in which the action situation is the predetermined situation, in a case where the action situation is the predetermined situation,
wherein at least one of the determination of the function performed by the function determination unit and a display of the associated display image performed by the image display unit is performed based on the collation result of the received action of another user and the detected action of another user.

8. The head mounted display device according to claim 1,
wherein the imaging unit detects a specific target set in advance from the outside scenes, and
wherein the action situation is the combination of the detected action and the specific target detected by the imaging unit.

9. The head mounted display device according to claim 1,
wherein the action detection unit is formed integrally on the image display unit and detects the action of the user based on an acceleration of the image display unit.

10. The head mounted display device according to claim 1,
wherein the action detection unit is formed separate from the image display unit and mounted on a body of the user, and detects the action of the user based on an acceleration of a mounted part of the user.

11. The head mounted display device according to claim 1, further comprising:
a situation detection unit that detects a situation of the outside scene,
wherein, in a case where the action situation is the predetermined situation and a detected situation of the outside scene is the predetermined situation, the function determination unit determines the function associated with the detected situation of the outside scene.

12. The head mounted display device according to claim 1,
wherein the predetermined situation is a combination of the image of the outside scene set in advance and the action of the user associated with the image of the outside scene set in advance.

13. A control method for a transmission type head mounted display device including an imaging unit that images an outside scene, and an image display unit that displays an image and is capable of transmitting the outside scene, the method comprising:
detecting an action of a user; and
determining a function which can be executed by the head mounted display device in a case where an action situation which is a combination of the detected action and the imaged outside scene is a predetermined situation.

14. An information system comprising a transmission type head mounted display device and an information storage device that stores local information,
wherein the head mounted display device includes:
an imaging unit that images an outside scene;
an image display unit that displays an image and is capable of transmitting the outside scene;
an action detection unit that detects an action of a user;
a position specification unit that specifies a current position of the image display unit, and
an information transmission and reception unit that transmits position information representing the specified current position to the information storage device,
wherein the information storage device includes a local information transmission unit that receives the transmitted position information of the image display unit and transmits the local information within a predetermined range from the position of the image display unit to the information transmission and reception unit,
wherein the information transmission and reception unit receives the transmitted local information, and
wherein the head mounted display device further includes:
a function determination unit that determines a function which can be executed by the head mounted display device in a case where an action situation which is a combination of the detected action and the imaged outside scene is a predetermined situation; and
a display image control unit that displays the image associated with the received local information on the image display unit.

15. A computer program for a transmission type head mounted display device that includes an imaging unit that images an outside scene and an image display unit that displays an image and is capable of transmitting the outside scene, the computer program causes a computer to implement:
an action detection function for detecting an action of a user; and
a function control function for determining a function which can be executed by the head mounted display device in a case where an action situation which is a combination of the detected action and the imaged outside scene is a predetermined situation.
